(19) United States
(12) Patent Application Publication
(10) Pub. No.: US 2016/0070701 A1
(43) Pub. Date: Mar. 10, 2016

(54) INDEXING ACCELERATOR WITH MEMORY-LEVEL PARALLELISM SUPPORT

(71) Applicant: HEWLETT-PACKARD DEVELOPMENT COMPANY, L.P., Houston, TX (US)

(72) Inventors: Kevin T. Lim, Palo Alto, CA (US); Onur Kocberber, Palo Alto, CA (US); Parthasarathy Ranganathan, Palo Alto, CA (US)

(21) Appl. No.: 14/888,237

(22) PCT Filed: Jul. 31, 2013
(86) PCT No.: PCT/US2013/053040

§ 371 Date: Oct. 30, 2015

(51) Int. Cl. G06F 17/30

(52) U.S. Cl. CPC G06F 17/3033

(57) ABSTRACT

According to an example, an indexing accelerator with memory-level parallelism (MLP) support may include a request decoder to receive indexing requests. The request decoder may include a plurality of configuration registers. A controller may be communicatively coupled to the request decoder to support MLP by assigning an indexing request of the received indexing requests to a configuration register of the plurality of configuration registers. A buffer may be communicatively coupled to the controller to store data related to an indexing operation of the controller for responding to the indexing request.

### BACKGROUND

Accelerators with on-chip cache locality typically focus on system on chip (SoC) designs that integrate a number of components of a computer or other electronic system into a single chip. The accelerators typically provide acceleration of instructions executed by a processor. The acceleration of instructions results in performance and energy efficiency improvements, for example, for in memory database processes.

### BRIEF DESCRIPTION OF DRAWINGS

Features of the present disclosure are illustrated by way of⁻example and not limited in the following figure(s), in which like numerals indicate like elements, in which:

FIG. 1 illustrates an architecture of an indexing accelerator with memory-level parallelism (MLP) support, according to an example of the present disclosure;

FIG. 2 illustrates a memory hierarchy including the indexing accelerator with MLP support of FIG. 1, according to an example of the present disclosure;

FIG. 3 illustrates a flowchart for context switching, according to an example of the present disclosure;

FIG. 4 illustrates a flowchart for allowing execution to move ahead by issuing prefetch requests on-the-fly, according to an example of the present disclosure;

FIG. 5 illustrates a flowchart for parallel fetching of multiple probe keys, according to an example of the present disclosure;

FIG. 6 illustrates a method for implementing an indexing accelerator with MLP support, according to an example of the present disclosure;

FIG. 7 illustrates further details of the method for implementing an indexing accelerator with MLP support, according to an example of the present disclosure; and

FIG. 8 illustrates a computer system for using an indexing accelerator with MLP support, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Accelerators that provide acceleration of instructions executed by a processor, for example, for indexing, may be designated as indexing accelerators. Indexing accelerators may include both specialized hardware and dedicated buffers for targeting relatively large data workloads. Such large data workloads may include segments of execution that may not be ideally suited for standard processors due to relatively large amounts of time spent accessing data and waiting on dynamic random-access memory (DRAM) (e.g., time spent chasing pointers through indexing structures). The indexing accelerators may provide an alternate and more energy efficient option for executing these data segments, while also allowing the main processor core to be put into a low power mode.

According to an example, an indexing accelerator that leverages high amounts of memory-level parallelism (MLP) is disclosed herein. The indexing accelerator disclosed herein may generally provide for a processor core to offload database indexing operations. The indexing accelerator disclosed herein may support one or more outstanding memory requests at a time. As described in further detail below, the support for a plurality of outstanding memory requests may be provided, for example, by incorporating MLP support at the indexing accelerator, allowing multiple indexing requests to use the indexing accelerator, allowing execution to move ahead by issuing prefetch requests on-the-fly, and supporting. parallel fetching of multiple probe keys to mitigate and overlap certain index-related on-chip cache miss penalties. The MLP support may allow the indexing accelerator to achieve higher performance than a baseline design without MLP support.

The indexing accelerator disclosed herein may support MLP by generally using inter-query parallelism, or by extracting the parallelism with data structure specific prefetching. MLP may be supported by allowing multiple indexing requests to use the indexing accelerator by including additional configuration registers in the indexing accelerator. Execution of indexing requests for queries may be allowed to move ahead by issuing prefetch requests for a next entry in a hash table chain. Further, the indexing accelerator disclosed herein may support parallel fetching of multiple probe keys to mitigate and overlap certain index-related on-chip cache miss penalties.

The indexing accelerator disclosed herein may generally include a controller that performs the indexing operation, and a relatively small cache data structure used to buffer any data encountered (e.g., touched) during the indexing operation. The controller may handle lookups into an index data structure (e.g., a red-black tree, a B-tree, or a hash table), perform any computation needed for the indexing (e.g., joining between two tables, or matching specific fields), and access to the data being searched for (e.g., database table rows that match a user's query). According to an example, the relatively small cache data structure may be 4-8 KB.

The indexing accelerator disclosed herein may target, for example, data-centric workloads that spend a relatively large amount of time accessing data. Such data-centric workloads may typically include minimal reuse of application data. As a result of the relatively large amounts of data being encountered, the locality of data structure elements (e.g., internal nodes within a tree) may tend to be low, as searches may have a relatively low probability of touching the same data. Data reuse may be useful for metadata such as table headers, schema, and constants that may be used to access raw data or calculate pointer addresses. The buffer of the indexing accelerator disclosed herein may facilitate indexing, for example, by reducing the use of a processor core primary cache for data that may not be used again. The buffer of the indexing accelerator disclosed herein may also capture frequently used metadata in database workloads (e.g., database schema and constants). The indexing accelerator disclosed herein may also provide efficiency for queries that operate on relatively small indexes, for example, by issuing multiple outstanding loads. Therefore, the indexing accelerator disclosed herein may provide acceleration of memory accesses for achieving improvements, for example, in performance and energy efficiency.

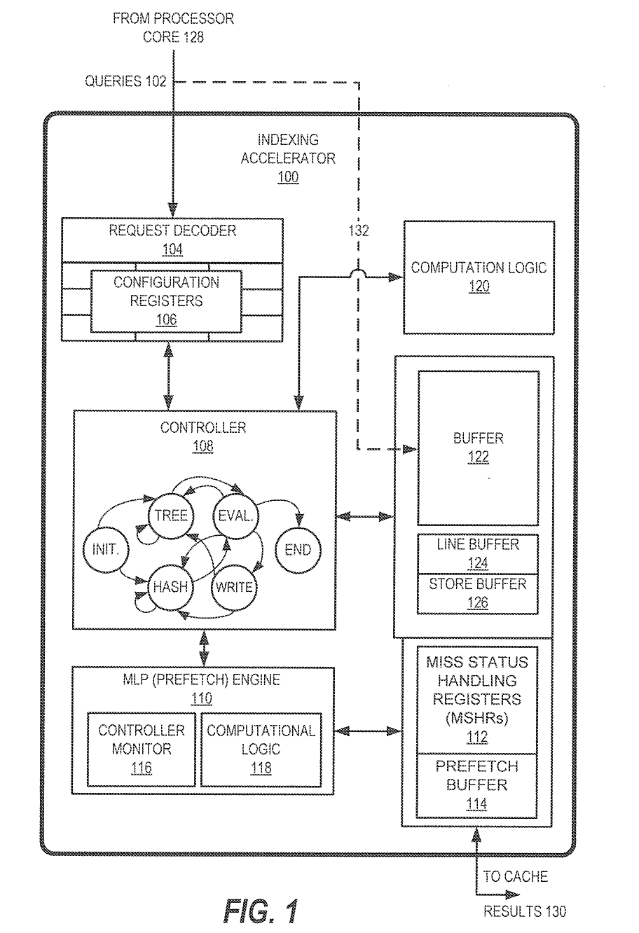

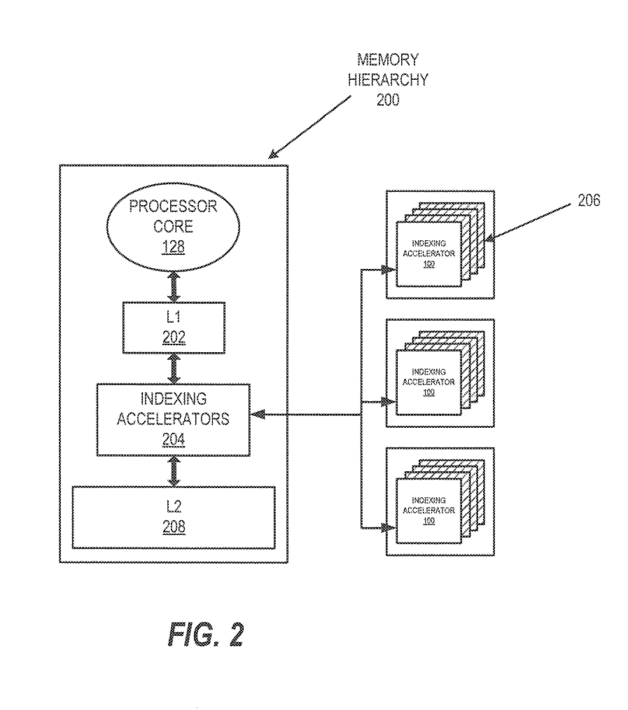

FIG. 1 illustrates an architecture of an indexing accelerator with MLP support 100 (hereinafter “indexing accelerator 100”), according to an example of the present disclosure. The indexing accelerator 100 may be a component of a SoC that provides for execution of any one of a plurality of specific requests (e.g., indexing requests) related to queries 102. Referring to FIG. 1, the indexing accelerator 100 is depicted as including a request decoder 104 to receive a number of requests corresponding to the queries 102 from a central processing unit (CPU) or a higher level cache (e.g., the L2 cache 202 of FIG. 2). The request decoder 104 may include a plurality of configuration registers 106 that are used during the execution, for example, of indexing requests for multiple queries 102. A controller (i.e., a finite state machine (FSM)) 108 may handle lookups into the index data structure (e.g., a red-black tree, a B-tree, or a hash table), perform any computation related to indexing (e.g., joining between two tables, or matching specific fields), and access data being searched for (e.g., the rows that match a user's query). The controller 108 may include an MLP (prefetch) engine 110 that provides for the issuing of prefetch requests via miss status handling registers (MSHRs) 112 or prefetch buffers 114. The MLP (prefetch) engine 110 may include a controller monitor 116 to create timely prefetch requests, and prefetch-specific computation logic 118 to avoid, contention on a primary indexing accelerator computation logic 120 of the indexing accelerator 100. The indexing accelerator 100 may further include a buffer (e.g., static random-access memory (SRAM)) 122 including a line buffer 124 and a store buffer 126.

The components of the indexing accelerator 100 that perform various other functions in the indexing accelerator 100, may comprise machine readable instructions stored on a non-transitory computer readable medium. In addition, or alternatively, the components of the indexing accelerator 100 may comprise hardware or a combination of machine readable instructions and hardware. For example, the components of the indexing accelerator 100 may be implemented on a SoC.

Referring to FIG. 1, the request decoder 104 may receive a number of requests corresponding to the queries 102 from a CPU or a higher level cache (e.g., the L2 cache 202 of FIG. 2). The requests may include, for example, offloaded database indexing requests. The request decoder 104 may decode these requests as they are received by the indexing accelerator 100.

The buffer 122 may be a fully associative cache that stores any data that is encountered during execution of the indexing accelerator 100. For example, the buffer 122 may be a relatively small (e.g., 4-8 KB) fully associative cache. The buffer 122 may provide for the leveraging of spatial and temporal locality.

The indexing accelerator 100 interface may be provided as a library, or as a software (i.e., machine readable instructions) application programming interface (API) of a database management system (DBMS). The indexing accelerator 100 may provide functions such as, for example, index creation and lookup. The library calls may be converted to specific instruction set architecture (ISA) extension instructions to setup and use the indexing accelerator 100. During invocations of the indexing accelerator 100, a processor core 128 executing a thread that is indexing may sleep while the indexing accelerator 100 is performing the indexing operation. Once the indexing operation is complete, the indexing accelerator 100 may push results 130 (e.g., found data in the form of a temporary table) to the processor's cache, and send the processor core 128 an interrupt, allowing the processor core 128 to continue execution. When the indexing accelerator 100 is not being used to index data, the components of the indexing accelerator 100 may be used for other purposes to augment a processor's existing cache hierarchy. Using the indexing accelerator 100 during idle periods may reduce wasted transistors, improve a processor's performance by providing expanded cache capacity, improve a processor's energy consumption by allowing portions of the cache to be shut down, and reduce periods of poor processor utilization by providing a higher level of optimizations.

During idle periods, the request decoder 104, the controller 108, and the computational logic 120 may be shut down, and a processor or higher level cache may be provided access to the buffer 122 of the indexing accelerator 100, For example, the request decoder 104, the controller 108, and the computational logic 120 may individually or in combination provide access to the buffer 122 by the core processor. Moreover, the indexing accelerator 100 may include an internal connector 132 directly connecting the buffer 122 to the processor core 128 for operation during such idle periods.

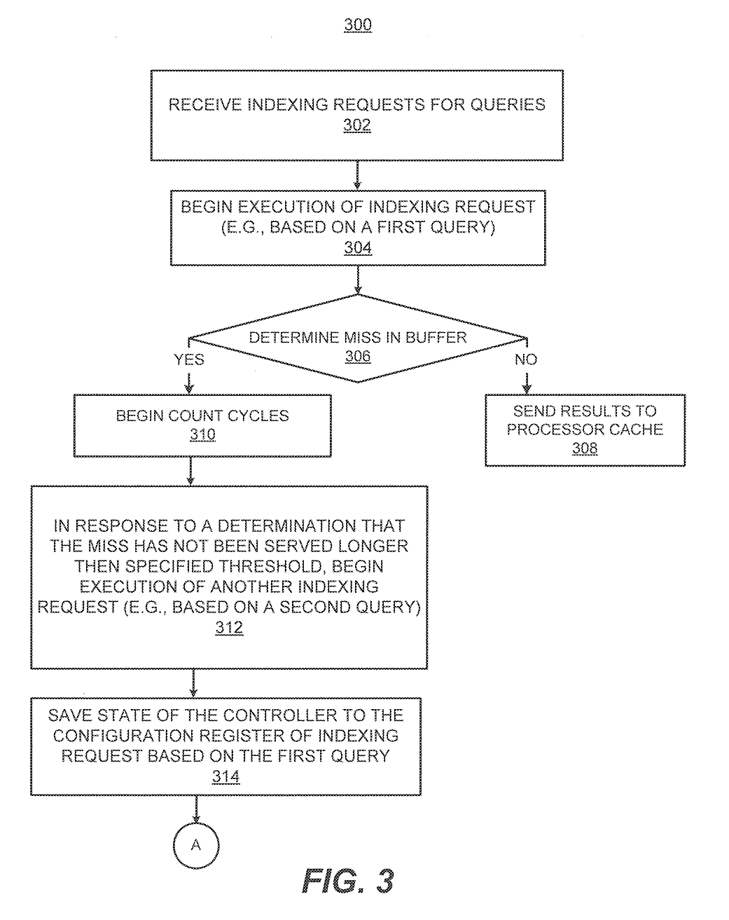

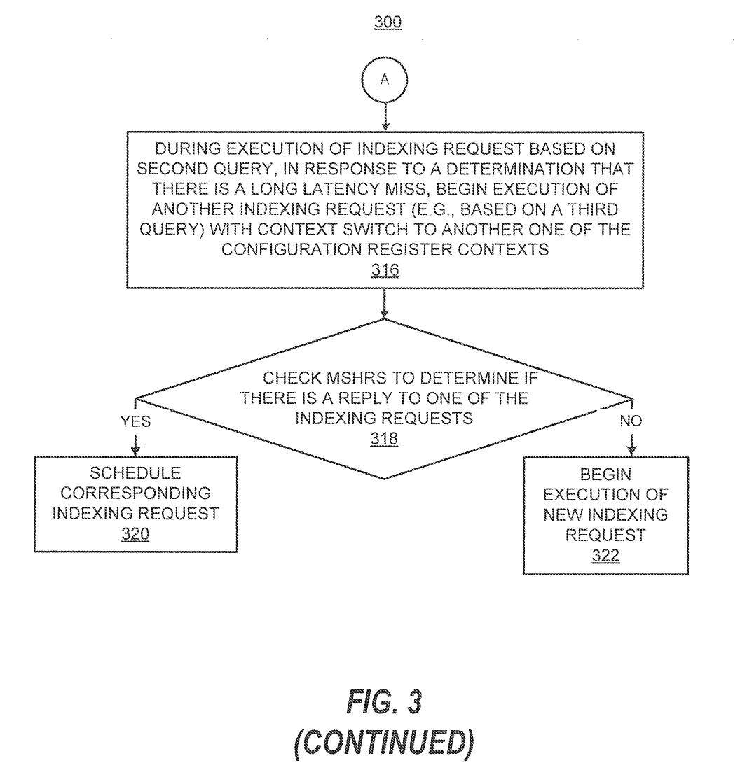

During idle periods of the indexing accelerator 100, the processor core 128 or higher level cache (e.g., the L2 cache 202 of FIG. 2) may use the buffer 122 as a victim cache, a miss buffer, a stream buffer, or an optimization buffer. The use of the buffer 122 for these different types of caches is described with reference to FIG. 2, before proceeding with a description of flowcharts 300, 400, and 500, respectively, of FIGS. 3-5, with respect to the MLP operation of the indexing accelerator 100.

FIG. 2 illustrates a memory hierarchy 200 including the indexing accelerator 100 of FIG. 1, according to an example of the present disclosure. The example of the memory hierarchy 200 may include the processor core 128, a level 1 (L1) cache 202, multiple indexing accelerators 204, which may include an arbitrary number of identical indexing accelerators 100 (three shown in the example) with an arbitrary number of additional configuration register contexts 206 (three shown with the shaded pattern in the example) corresponding to the configuration registers 106, and a L2 cache 208. During operation of the indexing accelerator 100, the processor core 128 may send a signal to the indexing accelerator 100 indicating, via execution of non-transitory machine readable instructions, that the indexing accelerator 100 is to index a certain location or search for specific data. After the various indexing tasks have been performed by the indexing accelerator 100, the indexing accelerator 100 may send an interrupt signal to the processor core 128 indicating that the indexing tasks are complete, and the indexing accelerator 100 is now available for other tasks.

Based on receipt of the indication that the indexing tasks are complete, the processor core 128 may direct the indexing accelerator 100 to flush any stale indexing accelerator 100 specific data in the buffer 122. Since the buffer 122 may have been previously used to cache data that the indexing accelerator 100 was using during indexing operations, clean data (e.g., tree nodes within an index, data table tuple entries, etc.) may be flushed out so that the data will not be inadvertently accessed while the indexing accelerator 100 is not being used as an indexing accelerator 100. If dirty or modified data remains in the buffer 122, the buffer 122 may provide for snooping by any lower caches (e.g., the L2 cache 208) such that those lower caches see that modified data and write back that modified data.

After the data has been flushed from the buffer 122, the controller 108 may be disabled. Disabling the controller 108 may prevent the indexing accelerator 100 from functioning as an indexing accelerator, and may instead allow certain components of the indexing accelerator 100 to be used for the various different purposes. For example, after disablement of the controller 108, the indexing accelerator 100 may be used as a victim cache, a miss buffer, a stream buffer, or an optimization buffer, as opposed to an indexing accelerator 100 with MLP (i.e., based on the MLP state of the controller 108). Each of these modes may be used during any idle period that the indexing accelerator 100 is experiencing.

As shown in FIG. 2, a plurality of indexing accelerators 100 may be placed between a plurality of caches in the memory hierarchy 200. For example, FIG. 2 may include a L3 cache with an indexing accelerator 100 communicatively coupling the L2 cache 208 with the L3 cache. According to another example, the indexing accelerator 100 may take the place of the L1 cache 202 and include a relatively larger buffer 122. For example, the buffer 122 size may exceed 8 KB of data storage (compared to 4-8 KB). As a result, instead of a controller within the L1 cache 202 taking over buffer operations, the indexing accelerator 100 may itself accomplish this task and cause the buffer 122 to operate under the different modes of victim cache, miss buffer, stream buffer, or optimization buffer during idle periods.

According to another example, the buffer 122 may be used as a scratch pad memory such that the indexing accelerator 100, during idle periods, may provide an interface to the processor core 128 to enable specific computations to be performed on the data maintained within the buffer 122. The computations allowed may be operations that are provided by the indexing hardware, such as comparisons or address calculations. This may allow flexibility in the indexing accelerator 100 by providing other ways to reuse the indexing accelerator 100.

As described herein, the indexing accelerator 100 may be used as a victim cache, a miss buffer, a stream buffer, or an optimization buffer during idle periods. However, the indexing accelerator 100 may be used as an indexing accelerator once again, and the processor core 128 may send a signal to the indexing accelerator 100 to perform indexing operations. When the processor core 128 sends a signal to the indexing accelerator 100 to perform indexing operations, the data contained in the buffer 122 may be invalidated. If the data contained in the buffer 122 is clean data, the data may be deleted, written over, or the addresses to the data may be deleted. If the data contained in the buffer 122 is dirty or altered, then that data may be flushed to the caches (e.g., L1 cache 202, L2 cache 208) within the memory hierarchy 200. After the buffer data in the indexing accelerator 100 has been invalidated, the controller 108 may be re-enabled by receipt of a signal from the processor core 128. If the L1 cache 202 had been disabled previously, the L1 cache 202 may also be re-enabled.

In order for the indexing accelerator 100 to provide MLP support, as described herein, the indexing accelerator 100 may generally include the MSHRs 112, the multiple configuration registers (or prefetch buffers) 106 for executing independent indexing requests, and the controller 108 with MLP support.

The MSHRs 112 may provide for the indexing accelerator 100 to issue outstanding loads. The indexing accelerator 100 may include, for example, 4-12 MSHRs 112 to exploit MLP. For the cases where there is no need to support an outstanding load (e.g., speculative loads), the prefetch buffer 114 of the same size may be used to avoid complexities of dependence checking hardware in the MSHRs 112. As the indexing accelerator 100 issues its off-indexing accelerator loads to the L1 cache 202, the number of outstanding misses that the L1 cache 202 can support may also bound the number of the MSHRs 112. The multiple configuration registers 106 may be used during the execution, for example, of indexing requests for multiple queries 102. The configuration register contexts 206 may share the same decoder since the format of the requests is the same. The controller 108 with the MLP support may provide for issuing of prefetch requests via the MSHRs 112 or the prefetch buffers 114. Both tree and hash states of the indexing accelerator 100 may initiate a prefetch request. The controller 108 may force a normal execution mod of the indexing accelerator 100 or cancel the prefetch operations arbitrarily by disabling the controller monitor 116 in the MLP (prefetch) engine 110.

In order to provide for MLP, the indexing accelerator 100 may provide support for multiple indexing requests to use the indexing accelerator 100, allow execution to move ahead by issuing prefetch requests on-the-fly, and support parallel fetching of multiple probe keys to mitigate and overlap certain index misses. Each of these aspects is described with reference to FIGS. 3-5.

With respect to providing support for multiple indexing requests to use the indexing accelerator 100, in transaction processing environments, inter-query parallelism may be prevalent as there may be thousands of transactions buffered and waiting for the execution cycles. Therefore, the indexing portion of these queries may be scheduled for the indexing accelerator 100. Even though the indexing accelerator 100 may execute one query at a time, the indexing accelerator 100 may switch its context (e.g., by the controller 108) upon a long-latency miss in the indexing accelerator 100 after issuing a memory request for a query 102. In order to support context switching, the indexing accelerator 100 may employ a configuration register 106 per context.

FIG. 3 illustrates a flowchart 300 for context switching, according to an example of the present disclosure. In this example, a DBMS which receives a plurality of the queries (e.g., thousands of queries) from users may be used. For each query, the DBMS may create a query plan that generally contains an indexing operation. The DBMS software (through its API) may send a predefined number of indexing requests related to the indexing operations to the indexing accelerator 100, instead of executing the indexing requests in software.

Referring to FIG. 3, at block 302, the indexing accelerator 100 including a set of the configuration registers 106 (e.g., 8 configuration registers) may receive indexing requests (e.g., indexing requests 1 to 8) for multiple queries 102 for acceleration. As described herein, the memory hierarchy 200 may include multiple indexing accelerators 204. Moreover, each indexing accelerator 100 may include a plurality of the configuration registers 106 including corresponding configuration register contexts 206, such as the three configuration register contexts 206 shown in FIG. 2.

At block 304, one of the received indexing requests (e.g., indexing request based on a first query) may begin execution. The execution of the indexing request may begin by reading the related information from one of the configuration register contexts 206 that has information for the indexing request under execution, Each configuration register context may include index-related information for one indexing request. The indexing request execution may include steps that calculate the address of an index entry and load/read addresses one by one until the requested entry (or entries) is located. The address calculation may include using the address of the base address of an index table, and adding offsets to the base address according the index table layout. Once the address of the index entry is calculated, the address may be read from the memory hierarchy 200. For example, the first entry of the index may be located by reading the base address of the index table and adding the base address with the length of each index entry, where these values may be sent to the indexing accelerator 100 during a configuration stage and reside in the configuration registers 106.

At block 306, the controller 108 may determine if there is a miss in the buffer 122, which means that the requested index entry is to be fetched from processor caches.

At block 308, in response to a determination that there is no miss, the results 130 may be sent to the processor cache if the found entry matches with a searched key.

At block 310, in response to a determination that there is a miss, the controller 108 (i.e., the FSM) may begin count cycles while waiting for the requested data to arrive from the memory hierarchy 200.

At block 312, in response to a determination that the miss has not been served longer than a specified threshold (e.g., hit latency of the L1 cache 202), the controller 108 may begin execution of another indexing request (e.g., based on a second query) with a context switch to another one of the configuration register contexts 206.

At block 314, the context switch operation may save the state of the controller 108 (i.e., the FSM state) to the configuration register 106. of the indexing request based on the first query. The state information may include the last state of the controller 108 and the MSHR 112 number that was used.

At block 316, during execution of the indexing request based on the second query, in response to a determination that there is a long latency miss, again the controller 108 may begin execution of another indexing request (e.g., based on a third query) with a context switch to another one of the configuration register contexts 206.

At block 318, during a context switch, the controller 108 may check the MSHRs 112 to determine if there is a reply to one of the indexing requests.

At block 320, in response to a determination that there is a reply to one of the indexing requests, the corresponding indexing request may be scheduled.

At block 322, in response to a determination that there is no reply to one of the indexing requests, a new indexing request may begin execution.

With respect to context switching, when a context switch is needed, if all the MSHRs 112 are full and/or there is no new query to begin, the execution may stall until one of the outstanding miss is served. Then the controller 108 may resume the corresponding context.

As described herein, in order to provide or MLP, the indexing accelerator 100 may provide support for multiple indexing requests to use the indexing accelerator, allow execution to move ahead by issuing prefetch requests on-the-fly, and support parallel fetching of multiple probe keys to mitigate and overlap certain index misses.

With respect to allowing execution to move ahead by issuing prefetch requests on-the-fly, the index execution may terminate when a searched key is found. In order to determine whether the searched key is found or not, at each level of the index, the comparisons against the found key and the searched key may be performed. The probability of finding the searched key in a first attempt may be considered low. Therefore the indexing accelerator 100 execution may speculatively move ahead and assume that the searched key is not found. The aspect of moving ahead by issuing prefetch requests on-the-fly may be beneficial for hash tables where the links may be accessed ahead of time once the first bucket is found, assuming that the table is organized with multiple arrays that are aligned to each other. Even if the table does not have an aligned layout, if processing each node needs additional computations besides comparing keys (e.g., updating a state in the node, indirectly stored node values, etc.), the indexing accelerator 100 may move ahead by skipping the computation and fetching the next node (i.e., dereferencing next link pointers) upon encounter. Moving ahead may also allow for overlapping of a long-latency load that may occur while moving from one link to another.

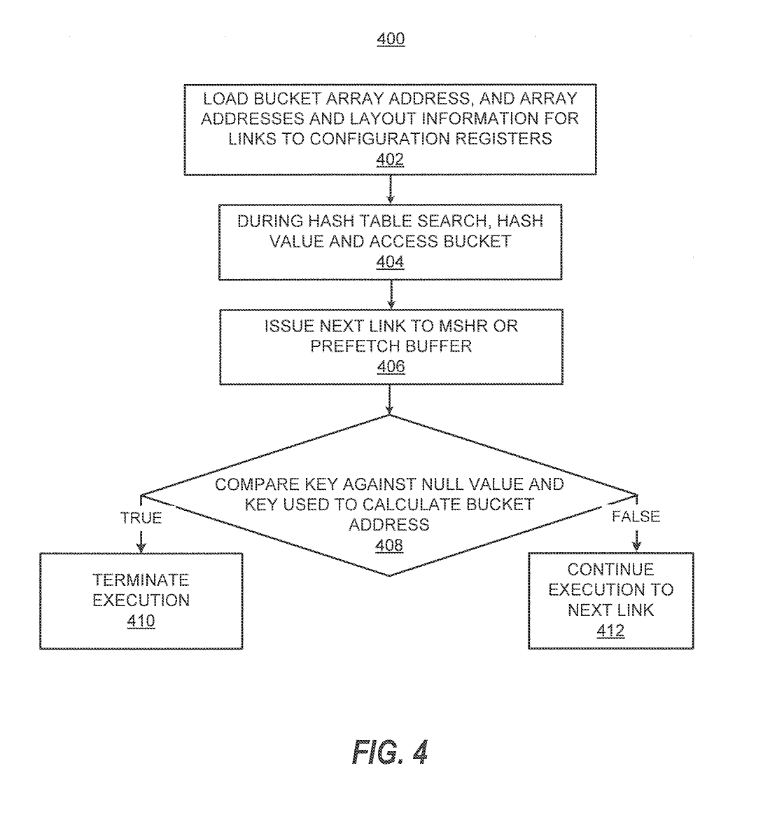

FIG. 4 illustrates a flowchart 400 for allowing execution to move ahead by issuing prefetch requests on-the-fly, according to an example of the present disclosure. The aspect of moving ahead may generally pertain to execution of an indexing request that has been submitted to a DBMS, and is eventually communicated to the indexing accelerator 100 via the software API in the DBMS. The aspect of moving ahead may further generally pertain to an indexing walk on a hash table.

Referring to FIG. 4, at block 402, during a configuration stage of indexing, in addition to a bucket array address (i.e., index table address), the array addresses and layout information (if different from a bucket array) for links may also be loaded to the configuration registers 106.

At block 404, during hash table search, the value (e.g., the key that the indexing request searches for) may be hashed and the bucket may be accessed.

At block 406, before reading the value within the bucket, the next link (which is the entry with the same offset but in a different array) may be issued to one of the MSHRs 112 or to the prefetch buffer 114. Similarly, if the hash table data structures are not aligned (i.e., connected via a pointer), then the indexing accelerator 100 may decide to read and dereference the pointer before reading the value within the bucket.

At block 408, the key may be compared against the null value (i.e., which means there is no such entry in the hash table) and the key used to calculate the bucket address.

At block 410, in response to a determination that one of the comparisons is true, the execution may terminate. This may imply that the last issued prefetch was unnecessary.

At block 412, in response to a determination that none of the comparisons is true, the execution may continue to the next link.

The example of FIG. 4 may pertain to a general hash table walk. Additional computation may be needed depending on the layout of the index entries (e.g., updating a state, performing additional comparison to index payload, etc.). The aspect of moving ahead may also be beneficial towards increased chances of overlapping access latency of a next link.

As described herein, in order to provide for MLR the indexing accelerator 100 may provide support for multiple indexing requests to use the indexing accelerator, allow execution to move ahead by issuing prefetch requests on-the-fly, and support parallel fetching of multiple probe keys to mitigate and overlap certain index misses.

With respect to support for parallel fetching of multiple probe keys to mitigate and overlap certain index misses, the moving ahead technique may provide for prefetching of the links within a single probe operation (i.e., moving ahead may exploit intra-probe parallelism). However, as described herein, the prefetching may start once the bucket header position is found (i.e., once the key is hashed). Therefore, the bucket header read may incur a relatively long--latency miss even with respect to allowing execution to move ahead by issuing prefetch requests on-the-fly.

To mitigate the first bucket header miss, the indexing accelerator 100 may exploit inter-probe parallelism as there may be a plurality (e.g., millions) of keys searched on a single index table for an indexing request (e.g., hash joins in data analytics workloads). To exploit such parallelism, the next probe key may be prefetched and the hash value may be calculated to issue the bucket header's corresponding entry in advance. Prefetching the next probe key may be performed based on the probe key access patterns as these keys are stored in an array in a DBMS and may follow a fixed stride pattern (e.g., add 8 bytes to the previous address). Prefetching the next probe key may be performed in advance so that the value may be hashed and the bucket entry may be prefetched.

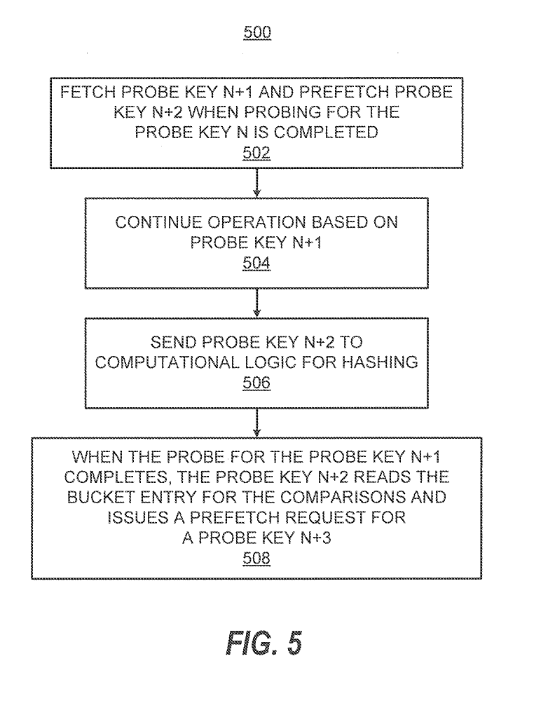

FIG. 5 illustrates a flowchart 500 for parallel fetching of multiple probe keys, according to an example of the present disclosure. The parallel fetching technique of FIG. 5 may be applied, for example, to a hash table index which may need to be probed with a plurality (e.g., millions) of keys. The parallel fetching technique of FIG. 5 may be applicable to hash joins, such as, joins that combine two database tables into one table. In order to expedite performance of the join operation, a smaller table of the database tables may be converted into a hash table index, and then probed by entries (i.e., keys) in the larger table of the database tables. For every matching entry, a result buffer may be populated and eventually the entries that reside in both tables may be located. Given that the larger table may include thousands to millions of entries, which may need to probe an index independently, such a scenario may include a substantial amount of inter-probe parallelism.

Referring to FIG. 5, at block 502, in order to perform parallel fetching from a large database table that is not converted into an index table, when probing for the probe key N is completed, the probe key N+1 may be fetched and the probe key N+2 may be prefetched.

At block 504, the probe key N+1 may continue normal operation of the indexing accelerator 100 by first hashing the probe key N+1, loading the bucket entry, and carrying out the comparison operations against NULL values (i.e., empty bucket entries), and looking for a possible match.

At block 506, while the probe key N+1 is busy with loads and comparisons, by using logic gates in the computational logic 120, the controller 108 may send the probe key N+2 to the computational logic 120 for hashing (if the probe key N+2 arrived in the meantime). Once the hashing is completed, a prefetch request may be inserted into the MSHRs 112 or to the prefetch buffer 114 to prefetch the bucket entry that corresponds to probe key N+2.

At block 508, when the probe for the probe key N+1 completes, the probe key N+2 may read the bucket entry (which was prefetched) for the comparisons and issue a prefetch request for a probe key N+3.

With respect to parallel fetching of multiple probe keys, the indexing accelerator 100 may use hashing to calculate the bucket position for a probe key. For example, the indexing accelerator 100 may employ additional computational logic 118 for the prefetching purposes or let the controller 108 arbitrate the computation logic 120 among the normal and prefetch operations. The additional computational logic 118 may be employed for prefetching purposes if the prefetch distance is larger than one. The prefetch distance of one may be ideal for hiding the operations with normal operations (i.e., prefetching more than one probe key may use a relatively long normal operation, and otherwise, calculating the prefetch addresses may use excessive execution time of the indexing accelerator 100).

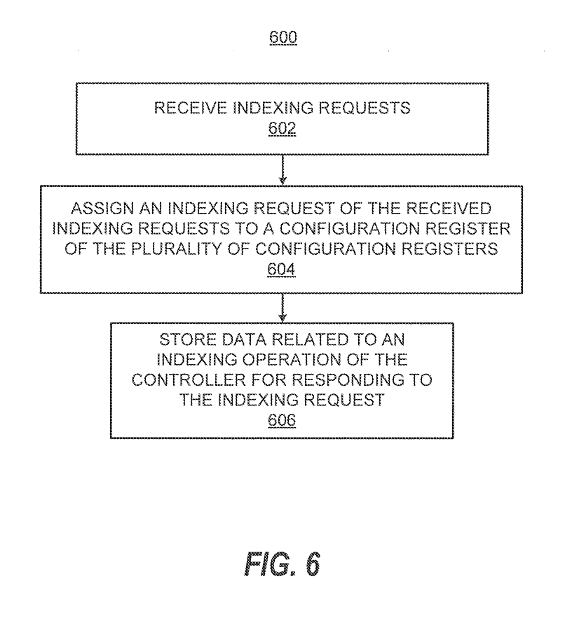

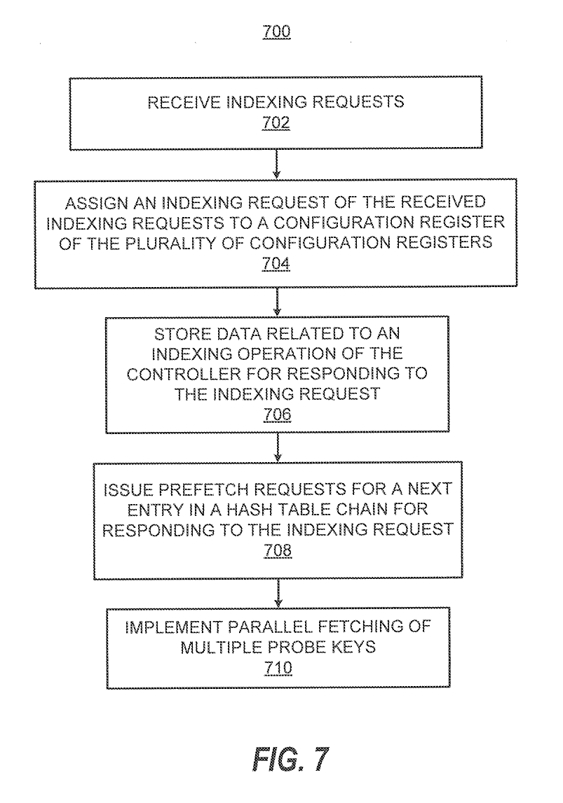

FIGS. 6 and 7 respectively illustrate flowcharts of methods 600 and 700 for implementing an indexing accelerator with MLP support, corresponding to the example of the indexing accelerator 100 whose construction is described in detail above. The methods 600 and 700 may be implemented on the indexing accelerator 100 with reference to FIGS. 1-5 by way of example and not limitation. The methods 600 and 700 may be practiced in other apparatus.

Referring to FIG. 6, for the method 600, at block 602, indexing requests may be received. For example, referring to FIGS. 1-5, the request decoder 104 may receive indexing requests for the queries 102.

At block 604, an indexing request of the received indexing requests may be assigned to a configuration register of the configuration registers. For example, referring to FIGS. 1-5, the controller 108 may be communicatively coupled to the request decoder 104 to support MLP by assigning an indexing request of the received indexing requests related to the queries 102 to a configuration register of the configuration registers 106.

At block 606, data related to an indexing operation of the controller for responding to the indexing request may be stored. For example, referring to FIGS. 1-5, the buffer 122 may be communicatively coupled to the controller 108 to store data related to an indexing operation of the controller 108 for responding to the indexing request.

Referring to FIG. 7, for the method 700, at block 702, indexing requests may be received. For example, referring to FIGS. 1-5, the request decoder 104 may receive indexing requests for the queries 102.

At block 704, an indexing request of the received indexing requests may be assigned to a configuration register of the configuration registers. For example, referring to FIGS. 1-5, the controller. 108 may be communicatively coupled to the request decoder 104 to support MLP by assigning an indexing request of the received indexing requests related to the queries 102 to a configuration register of the configuration registers 106.

At block 706, data related to an indexing operation of the controller for responding to the indexing request may be stored. For example, referring to FIGS. 1-5, the buffer 122 may be communicatively coupled to the controller 108 to store data related to an indexing operation of the controller 108 for responding to the indexing request.

At block 708, execution of the indexing request may move ahead by issuing prefetch requests for a next entry in a hash table chain for responding to the indexing request. For example, referring to FIGS. 1-5, the controller 108 may provide for execution of the indexing request to move ahead by issuing prefetch requests for a next entry in a hash table chain for responding to the indexing request. Further, execution of the indexing request may move ahead by issuing the prefetch requests via the MSHRs 112.

At block 710, parallel fetching of multiple probe keys may be implemented. For example, referring to FIGS. 1-5, the controller 108 may implement parallel fetching of multiple probe keys.

According to another example, the controller 108 may support MLP by determining if there is a miss during execution of the indexing request, where the execution of the indexing request corresponds to a configuration register context of the configuration register, and where the indexing request is designated a first indexing request, and the configuration register context of the configuration register is designated a first configuration register context of a first configuration register. In response to a determination that there is no miss during the execution of the first indexing request, the indexing accelerator 100 may forward results of the execution of the first indexing request to a processor cache. Further, in response to a determination that there is a miss during the execution of the first indexing request, the controller 108 may begin count cycles, and in response to a determination that the miss has not been served longer than a specified threshold based on the count cycles, the controller 108 may begin execution of another indexing request with a context switch to a configuration register context of another configuration register. According to another example, a state of the controller 108 may be saved to the first configuration register. According to a further example, the MSHRs 112 (or the prefetch buffer 114) may be checked to determine if there is a reply to one of the indexing requests.

According to another example, the controller 108 may implement parallel fetching of multiple probe keys by determining if probing for a probe key N is completed, and in response to a determination that probing for the probe key N is completed, the controller 108 may fetch a probe key N+1, and prefetch a probe key N+2.

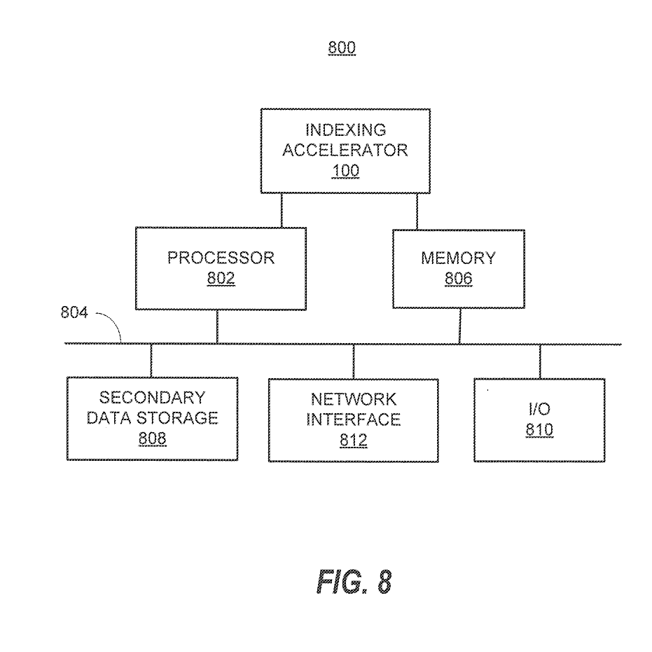

FIG. 8 shows a computer system 800 that may be used with the examples described herein. The computer system may represent a generic platform that includes components that may be in a server or another computer system. The computer system 800 may be used as a platform for the indexing accelerator 100. The computer system 800 may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 800 may include a processor 802 that may implement or execute machine readable instructions performing some or all of the methods, functions and other processes described herein. Commands and data from the processor 802 may be communicated to and received from the indexing accelerator 100. Moreover, commands and data from the processor 802 may be communicated over a communication bus 804. The computer system may also include a main memory 806, such as a random access memory (RAM), where the machine readable instructions and data for the processor 802 may reside during runtime, and a secondary data storage 808, which may be non-volatile and stores machine readable instructions and data. The memory and data storage are examples of computer readable mediums.

The computer system 800 may include an I/O device 810, such as a keyboard, a mouse, a display, etc. The computer system may include a network interface 812 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An indexing accelerator with memory-level parallelism (MLP) comprising:
a request decoder to receive indexing requests and including a plurality of configuration registers;
a controller communicatively coupled to the request decoder to support MLP by assigning an indexing request of the received indexing requests to a configuration register of the plurality of configuration registers; and
a buffer communicatively coupled to the controller to store data related to an indexing operation of the controller for responding to the indexing request.

2. The indexing accelerator with MLP support according to claim 1, wherein the controller, to support MLP, is to further:
provide for execution of the indexing request to move ahead by issuing prefetch requests for a next entry in a hash table chain for responding to the is indexing request.

3. The indexing accelerator with MLP support according to claim 2, wherein the controller, to support MLP, is to further:
provide for the execution of the indexing request to move ahead by issuing the prefetch requests via miss status handling registers (MSHRs) or prefetch buffers.

4. The indexing accelerator with MLP support according to claim 1, wherein the controller, to support MLP, is to further:
determine if there is a miss during execution of the indexing request, wherein execution of the indexing request corresponds to a configuration register context of the configuration register, and wherein the indexing request is designated a first indexing request, and the configuration register context of the configuration register is designated a first configuration register context of a first configuration register;
in response to a determination that there is no miss during the execution of the first indexing request, forward results of the execution of the first indexing request to a processor cache; and
in response to a determination hat there is a miss during the execution of the first indexing request:
begin count cycles; and
in response to a determination that the miss has not been served longer than a specified threshold based on the count cycles, begin execution of another indexing request with a context switch to a configuration register context of another configuration register.

5. The indexing accelerator with MLP support according to claim 4, wherein the controller, to support MLP, is to further:
save a state of the controller to the first configuration register.

6. The indexing accelerator with MLP support according to claim 4, wherein the controller, to support MLP, is to further:
check miss status handling registers (MSHRs) to determine if there is a reply to one of the indexing requests.

7. The indexing accelerator with MLP support according to claim 1, wherein the controller, to support MLP, is to further:
implement parallel fetching of multiple probe keys.

8. The indexing accelerator with MLP support according to claim 7, wherein the controller, to implement parallel fetching of multiple probe keys, is to further:
determine if probing for a probe key N is completed; and
in response to a determination that probing for the probe key N is completed:
fetch a probe key N+1, and
prefetch a probe key N+2.

9. The indexing accelerator with MLP support according to claim 1, wherein the indexing accelerator with MLP support is implemented as a system on chip (SoC).

10. A method for implementing an indexing accelerator with memory-level parallelism (MLP) support, the method comprising:
receiving indexing requests;
assigning an indexing request of the received indexing requests to a configuration register of a plurality of configuration registers;
storing data related to an indexing operation of a controller o responding to the indexing request; and
executing the indexing request by moving ahead by issuing prefetch requests for a next entry in a hash table chain for responding to the indexing request.

11. The method of claim 10, further comprising:
determining if there is a miss during the execution of the indexing request, wherein the execution of the indexing request corresponds to a configuration register context of the configuration register, and wherein the indexing request is designated a first indexing request, and the configuration. register context of the configuration register is designated a first configuration register context of a first configuration register;
in response to a determination that there is no miss during the execution of the first indexing request, forwarding results of the execution of the first indexing request to a processor cache; and
in response to a determination that there is a miss during the execution of he first indexing request:
beginning count cycles; and
in response to a determination that the miss has not been served longer than a specified threshold based on the count cycles, beginning execution of another indexing request with a context switch to a configuration register context of another configuration register.

12. The method of claim 11, further comprising:
saving a state of the controller to the first configuration register.

13. The method of claim 11, further comprising:
checking miss status handling registers (MSHRs) to determine if there is a reply to one of the indexing requests.

14. The method of claim 10, further comprising:
implementing parallel fetching of multiple probe keys.

15. The method of claim 11, wherein implementing parallel fetching of multiple probe keys further comprises:
determining if probing for a probe key N is completed; and
in response to a determination that probing for the probe key N is completed:
fetching a probe key N+1, and
prefetching a probe key N+2.
